(19) United States
(12) Patent Application Publication
(10) Pub. No.: US 2009/0126960 A1
(43) Pub. Date: May 21, 2009

(54) Portable Power Tool with Drive Shaft Lock Means

(75) Inventor: Nabil Khalil Radif, Stockholm (SE)

Correspondence Address: FRISHAUF, HOLTZ, GOODMAN & CHICK, PC, 220 Fifth Avenue, 16TH Floor, NEW YORK, NY, 10001-7708, US

(73) Assignee: Atlas Copco Tools AB, Nacka (SE)

(21) Appl. No.: 12/227,050

(22) PCT Filed: May 7, 2007
(86) PCT No.: PCT/SE2007/000433

§ 371 Date: Dec. 5, 2008

(30) Foreign Application Priority Data
May 9, 2006 (SE) 0601027-6

(51) Int. Cl. B25F 5/00

(52) U.S. Cl. 173/164

(57) ABSTRACT

A portable power tool with a rotation motor (11) drivingly connected to a working implement carrying chuck (16) via a drive shaft (13), wherein a rotation locking mechanism (19) is arranged to lock the drive shaft (13) for enabling tightening or loosening the chuck (16) at attachment or removal of a working implement, wherein axial key surfaces (31) on the drive shaft (13) are arranged to be selectively engaged by mating key surfaces (32) on an axially movable but substantially non-rotative coupling unit (33,34) as the latter is shifted from an inactive rest position to an active position.

The invention relates to a portable power tool with a drive shaft connected at a driven end to a rotation motor and at a driving end to a working implement, wherein a manually operable lock means is provided to prevent rotation of the drive shaft at shifting of working implement.

In power tools of this type, for instance drilling machines, there is a need for locking the drive shaft against rotation during exchange of working tool, because the tool chuck is always opened and closed by a spanner, and for avoiding the need for two spanners, one extra for holding the drive shaft, there is employed a drive shaft lock means. In for instance power grinders there have been used a lock means of the pawl type wherein a manually operable pawl is brought into engagement with an abutment on or aperture in the drive shaft.

There is always a risk that a lock devices of this type is unintentionally activated during full speed rotation of the tool, but in power grinders that risk is very small due to a high operation speed. The lock pawl is unable to get into engagement with the drive shaft during the extremely short time interval the aperture in the drive shaft coincides with pawl. In low speed tools, however, like drilling machines with a rotation speed of typically 1/10 of the speed of a power grinder, a locking pawl might enter an aperture in the drive shaft and cause a very abrupt and self-destructive stop to the rotating parts of the tool and also a dangerous energy transfer to the tool housing and the operator.

In the previously used pawl type drive shaft lock means there is required at least one aperture to be provided in the drive shaft which means a weakening of the drive shaft, especially in smaller size tools having small diameter drive shafts.

The main object of the invention is to create a portable power tool with a rotating drive shaft where a two-way locking of the drive shaft is accomplished with a reduced risk for unintentional activation of the lock means and without any weakening of the drive shaft.

Further characteristic features and advantages of the invention will appear from the following specification and claims.

A preferred embodiment of the invention is described below with references to the accompanying drawing.

In the drawings

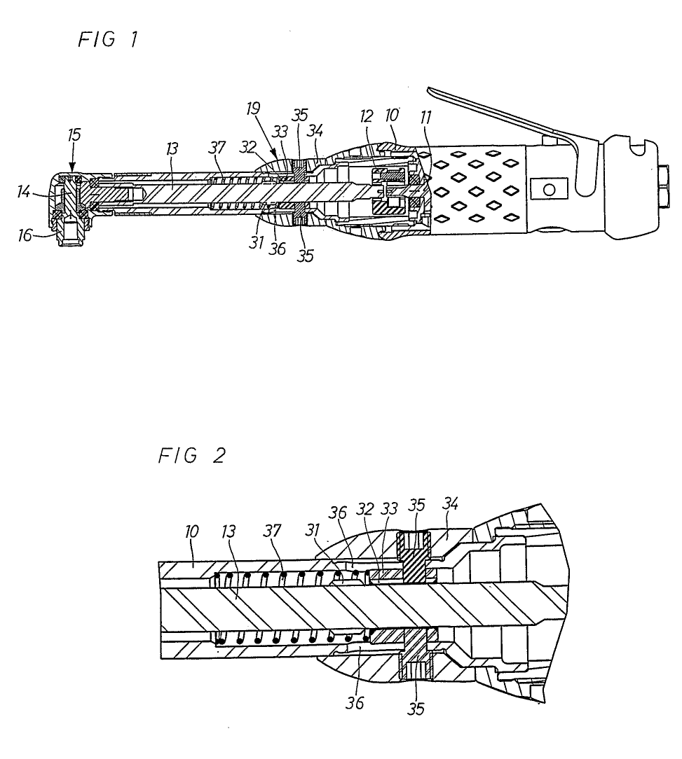

FIG. 1 shows a longitudinal section through a power tool according to the invention.

FIG. 2 shows, on a larger scale, a fractional view of the drive shaft locking mechanism of the power tool in FIG. 1.

The power tool illustrated in FIGS. 1 and 2 is a pneumatic drilling tool which comprises a housing 10, a rotation motor 11, a reduction gearing 12, a drive shaft 13, an angle head 15, and an output shaft 14 supported in the angle head 15 and carrying a chuck 16 for attachment of a working implement. The drive shaft 13 extends between the reduction gearing 12 and the angle head 15.

The drive shaft 13 is formed with an engagement portion in the form of axially directed key surfaces 31 arranged to form a spline connection with mating key surfaces 32 on a movable coupling sleeve 33. The coupling sleeve 33 is connected to a maneuver ring 34 via radial pins 35, and the maneuver ring 34 is axially displaceable relative to the housing 10 in a coaxial disposition relative to the drive shaft 13. The movement of the maneuver ring 34 and the coupling sleeve 33 is controlled by the pins 35 which are running in axially directed slots 36 in the housing.

In a non-illustrated alternative design the coupling sleeve 33 and the maneuver ring 34 are rotatable over a limited angular interval in combination with their axial displacements between the inactive and active positions, whereby there is obtained a facilitated shifting of the coupling sleeve 33 against the bias force of the spring 37. Such a combined axial and rotating movement is obtained by having the slots 36 screw shaped.

The coupling sleeve 33 is shiftable by means of the maneuver ring 34 between a rear inactive rest position and a forward active lock position, and a spring 37 is arranged to exert a bias force on the coupling sleeve 33 in the direction of the rest position. In its inactive rest position the coupling sleeve 33 occupies its rearmost position where the key surfaces 31,32 on the drive spindle 13 and the coupling sleeve 33, respectively, are out of engagement. In order to lock the drive spindle 13 against rotation at tightening or opening the chuck 16 the maneuver ring 34 together with the coupling sleeve 33 are displaced forwardly, against the bias force of the spring 37 so as to accomplish engagement between the key surfaces 32 of the coupling sleeve 33 and the key surfaces 31 on the drive spindle 13. After an intended working implement attachment/removal operation is completed the maneuver ring 34 and the coupling sleeve 33 are allowed to return to their rest positions by the force of the spring 37.

1-5. (canceled)

6. A portable power tool, comprising:
a housing,
a rotation motor,
a drive shaft connected at a driven end thereof to the motor and drivingly coupled at a driving end thereof to a working implement carrying chuck, and
a manually operable lock device for locking the drive shaft against rotation at loosening and tightening of the chuck,
wherein said lock device comprises:
an engagement portion rigidly associated with said drive shaft, and
a coupling unit substantially non-rotatable but axially displaceable relative to the housing,
wherein said coupling unit is manually shiftable between an inactive rest position an an active locking position,
wherein interengagement is obtained between the coupling unit and the engagement portion of the drive shaft for accomplishing a locking of the drive shaft against rotation relative to the housing, and
wherein a spring is arranged to bias said coupling unit toward said inactive rest position.

7. The power tool according to claim 6, wherein said engagement portion and said coupling unit are formed with a number of axially directed mating key surfaces, and said key surfaces are arranged to interengage in a spline connection as said coupling unit is displaced into said at least one active position only.

8. The power tool according to claim 7, wherein said engagement portion is formed integral with the drive shaft.

9. The power tool according to claim 6, wherein said engagement portion is formed integral with the drive shaft.

10. The power tool according to claim 6, wherein said coupling unit comprises an external maneuver ring supported on the housing in a substantially concentric disposition relative to the drive shaft.

11. The power tool according to claim 7, wherein said coupling unit comprises an external maneuver ring supported on the housing in a substantially concentric disposition relative to the drive shaft.

12. The power tool according to claim 8, wherein said coupling unit comprises an external maneuver ring supported on the housing in a substantially concentric disposition relative to the drive shaft.

13. The power tool according to claim 9, wherein said coupling unit comprises an external maneuver ring supported on the housing in a substantially concentric disposition relative to the drive shaft.

14. The power tool according to claim 6, wherein said coupling unit is rotatable over a limited angular interval in combination with an axial displacement between said inactive rest position and said active position.

15. The power tool according to claim 7, wherein said coupling unit is rotatable over a limited angular interval in combination with an axial displacement between said inactive rest position and said active position.

16. The power tool according to claim 8, wherein said coupling unit is rotatable over a limited angular interval in combination with an axial displacement between said inactive rest position and said active position.

17. The power tool according to claim 9, wherein said coupling unit is rotatable over a limited angular interval in combination with an axial displacement between said inactive rest position and said active position.

18. The power tool according to claim 10, wherein said coupling unit is rotatable over a limited angular interval in combination with an axial displacement between said inactive rest position and said active position.

19. The power tool according to claim 11, wherein said coupling unit is rotatable over a limited angular interval in combination with an axial displacement between said inactive rest position and said active position.

20. The power tool according to claim 12, wherein said coupling unit is rotatable over a limited angular interval in combination with an axial displacement between said inactive rest position and said active position.

21. The power tool according to claim 13, wherein said coupling unit is rotatable over a limited angular interval in combination with an axial displacement between said inactive rest position and said active position.
